(19) United States
(12) Patent Application Publication
(10) Pub. No.: US 2015/0234608 A1
(43) Pub. Date: Aug. 20, 2015

(54) METHOD AND SYSTEM FOR GROUP REPLICATION AND SHIPPING OF DIGITAL MEDIA

(71) Applicant: THOMSON LICENSING, Issy de Moulineaux (FR)

(72) Inventors: Ryan John SORENSEN, Valencia, CA (US); William Gibbens Redmann, Glendale, CA (US)

(21) Appl. No.: 14/602,652

(22) Filed: Jan. 22, 2015

Related U.S. Application Data
(60) Provisional application No. 61/941,555, filed on Feb. 19, 2014.

(51) Int. Cl. G06F 3/06

(52) U.S. Cl. CPC G06F 3/0619; G06F 3/065; G06F 3/067

(57) ABSTRACT

A method for replicating content onto storage devices for shipping to a common destination commences by first grouping work orders that specify replication of content onto a plurality of storage devices associated a common destination into a group replication job. The content specified in the group replication job is replicated onto the plurality of storage devices content specified in the group replication job. Thereafter, the content storage devices now replicated with content are readied for shipping to the common destination.

### TECHNICAL FIELD

This invention relates to replication of content onto multiple storage devices, such as hard disk drives.

### BACKGROUND ART

The exhibition of digital cinema requires the distribution of large amounts of digital content to exhibition theatres. While some theaters can accept satellite or other broadband delivery, the majority of theaters, including those now converting from film, will require physical delivery of digital content replicated onto storage devices such as hard disk drives, for some time. The need to deliver content storage devices physically to exhibition theaters represents a demand for many hundreds of content storage devices for each movie release. Presently, content replicators ship individual content storage devices containing one or more feature presentations, along with one or more shorts, advertisement and/or trailers, to exhibition theatres. On a weekly basis, a content replicator may individually ship several content storage devices to a given theater. The coordination and inventory control necessary to bulk replicate and inventory content storage devices containing different content and the picking and packing of such content storage devices for a single exhibition theatre represents a complex undertaking. Often, these tasks require more resources and manpower than is consistently warranted. Further, errors in picking and packing devices (e.g., when an operator pulls and packs an incorrect content storage device) take valuable time to correct. These errors tend to cascade, creating additional difficulties such as when an operator restocks an erroneously pulled content storage device).

The difficulties associated with replicating and inventorying content storage devices differs from inventorying retail goods. The content storage devices inventoried for distribution to individual exhibition theaters all have the same general physical appearance (with the exception of their individual barcodes). Further, visual inspection of a content storage device will not reveal the nature of the content replicated onto that device, which further changes over time. Past approaches for content storage device replication, such as those disclosed in International Patent Publications WO2013137940 and WO2013181746, both filed in the name of Technicolor, Inc. have focused on single content storage devices shipped independently to individual exhibition theaters, and thus do not address the difficulties associated with shipping a group of content storage devices to an individual exhibition theater.

Thus, a need exits for a technique that better manages the copying of content to a group of content storage devices for shipment together to a particular exhibition theater, so that theatre receives the correct content. Further, a need exists for a technique for efficiently copying, grouping, and shipping content storage devices as a group with low risk of failure due to technical faults or operator error.

### BRIEF SUMMARY OF THE INVENTION

A method for replicating content onto storage devices for shipping to a common destination commences by first grouping work orders that specify replication of content onto a plurality of storage devices associated a common destination into a group replication job. The content specified in the group replication job is replicated onto the plurality of storage devices content specified in the group replication job. Thereafter, the content storage devices now replicated with content are readied for shipping to the common destination the plurality of content storage devices in the group replication job.

### BRIEF DESCRIPTION OF THE DRAWINGS

FIG. 1 illustrates a block diagram of a content replication system and its process of operation;

FIG. 2 illustrates a more detailed block diagram of the content replication system of FIG. 1 depicting signaling indicating the different status of the content storage devices;

FIG. 3 illustrates a process for replicating a group of content storage devices as a single job; and,

FIG. 4 illustrates a state diagram for a content storage device group job.

### DETAILED DESCRIPTION

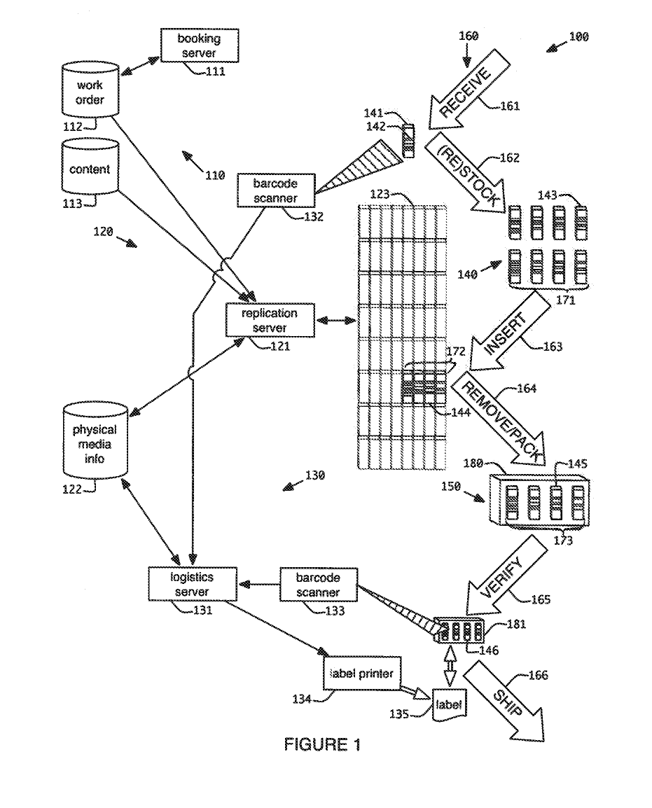

FIG. 1 illustrates a block diagram of a system 100 and its process of operation 160 in accordance with the present principles, for grouping work orders for content replication for a common destination, e.g., a single exhibition theater (not shown). The system 100 comprises a booking system 110, a replication system 120, and a distribution system 130. The operation and use of these systems will become readily apparent in the context of the operation of the system 100 described hereinafter. The booking system 110 comprises a booking server 111 and a work order database 112. Studios or other content owners, or agents for them (collectively referred hereinafter as “clients”) interact with the booking server 111 to enter content replication orders. For example, a client can connect with the booking server 111 through a web services interface (not shown) to establish a secure user interface that allows the client, once authorized, to log into its account. Once logged in, the client can issue work orders for replication of content associated with that account (i.e., content which the client has the authority to control). The work order identifies the specific content for replication and the content delivery destination(s), typically one or more exhibition theaters. The work order database 112 stores work orders entered via the booking server 111.

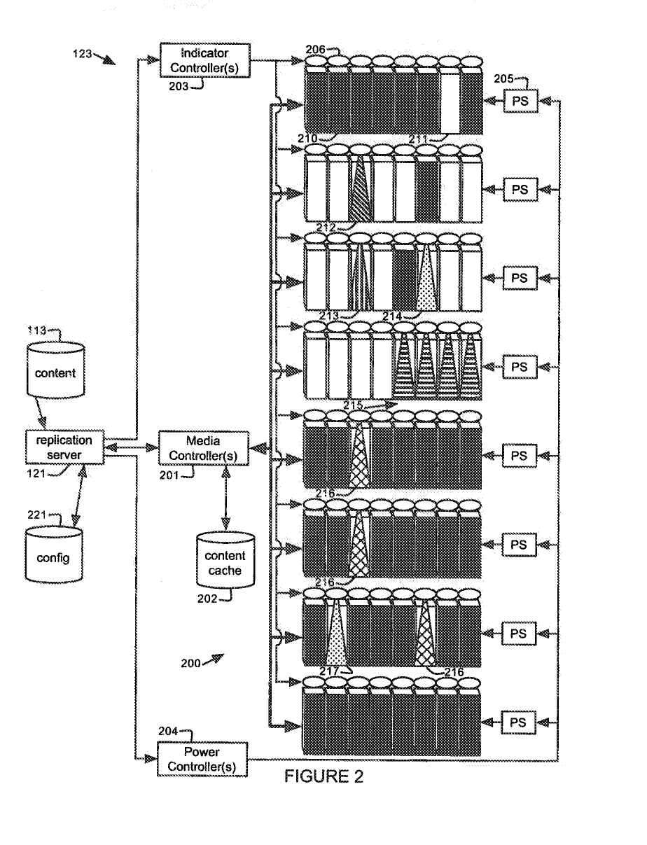

The replication system 120 comprises a replication server 121 that accesses the work order database 112 since work orders control the operation of the replication system 120. The replication server 121 also connects to one or more replication arrays 123. As discussed in greater detail in conjunction with FIG. 2, each replication array 123 physically mounts individual content storage devices (e.g., hard disk content storage devices) and electrically interfaces such storage device(s) to the content replication server 121 so that server can replicate content onto such device(s). For ease of discussion, an incoming content storage device initially received by the system 100 for replication bears the reference number 141. Each content storage device staged for insertion into the array 123 bears the reference numeral 143, whereas those content storage devices that have undergone replication and but await distribution each bear the reference numeral 145. Those content storage devices packaged for shipment together each bear the reference numeral 146. Each content storage device has a unique, machine-readable indicia 142, e.g., the barcode shown on storage device 141, usable by the system 100 as one way to identify unambiguously the storage device.

The content store 113 typically comprises a network storage system and/or one or more physical content storage devices for storing content for replication by the replication system 120. Often, the system 100 will preload the content needed for replication onto the content store 113 during an ingest procedure. Alternatively, or in addition to such content preloading, the content store 113 can receive content from post-production facilities that perform operations on previously unfinished content. The replication system 120 can also receive content from sources besides the content store 113 as discussed further in conjunction with FIG. 2, below.

As discussed above, the booking system 110 receives work orders from clients. An exemplary booking system comprises the Theatrical Distribution System (TDS) offered by Cinedigm Digital Cinema Corp., of Morristown, N. J. Another exemplary system comprises the Studio Portal, by Technicolor Digital Cinema, of Burbank, Calif. Several major movie studios use these products for booking orders for replication of digital cinema presentations (e.g., movies), while others studios have developed their own such systems. Regardless of the mechanism by which clients enter work orders, the system 100 stores work orders received from clients in the work order database 112 for access by the replication system 120 in order to determine which content needs replication for which destinations.

In embodiments where clients make use of a plurality of different booking servers 110, the work order database 112 can have one or more adaption layers (not shown), each providing an interface to a particular booking system. In an alternative embodiment, each of the various different booking servers 110 might have its own a corresponding work order database 112, in which case, replication server 121 will have access to such individual work order databases. Regardless variety or type of booking systems available, the work order database(s) 112 serve as the interface between the booking system(s) 110 and the replication system 120.

In accordance with the present principles, the replication server 121 has the ability to derive and group replication jobs for a common destination (e.g., an exhibition theater) from the work orders in the work order database 112. Further, the replication server 121 also has the ability to prioritize replication jobs. Prioritization typically depends on due dates, delivery schedules, the availability of content (e.g., the availability of content in the content store 113), explicitly supplied work order priorities (e.g., “rush” orders), and/or work order priority policies (e.g., all other things being equal, long-time customers take priority over new customers; large orders take priority over small orders).

As discussed above, the system 100 comprises a distribution system 130, which includes a distribution and logistics server 131. The distribution and logistics server 131 tracks each incoming content storages device 141, each identified by unique indicia 142, and further tracks tracking content storage devices 143, each bearing their own indicia, staged an inventory 140 as they await replication. Further, the distribution and logistics server 131 of the distribution system 130 also tracks content storage devices 145, already replicated and processes those content storage devices for shipping.

The replication system 120 interfaces with the distribution system 130 at three places: First, the replication system 120 interfaces to a physical media information database 122 used by both the replication server 121 and the distribution and logistics server 131 to track the status of individual content storage devices. Second, the distribution and logistics server 131 of the distribution system 130 arranges for the staging of the content storage devices 143 in the inbound inventory 140 for use by the replication system 120. Third, the distribution and logistics server 131 of the distribution system 130 arranges for the staging of the content storage devices 145 successfully written by the replication system 120 in an outbound inventory 150 for shipment.

Generally, each work order takes the form of an explicit list of content (e.g., digital cinema presentations, shorts, advertisement and/or trailers) for replication and a list of one or more content destinations (e.g., exhibition theaters) that should receive such content. Electronic content distribution systems that make use of broadband or satellite transmission, for example, can fulfill some work orders, or portions thereof, depending upon the exhibition theater's capabilities and the booking entities' instructions. Such electronic distributions exist separately from those that replicate content onto physical storage devices but do not address the functionality of the replication and distribution systems 120 and 130, respectively, shown here.

In addition to the list of content and intended destination(s), each work order typically includes additional information, such as the show date and the length of run of the content for a given destination. Using the show date, the, replication server 121 can determine possible shipping dates, using rules that take into account available shippers, classes of shipping (e.g., courier, next-day-first, next-day, second-day, etc.), and the corresponding costs, among other factors. The replication server 121 accounts for possible shipping dates and costs to optimize the priority associated with the various replication jobs. For example, the replication server 121 might delay a replication of a small job, for example, just a few content storage devices and incur higher shipping costs in order to complete a large replication job (many content storage devices) so to take advantage of a lower shipping cost. The length of run determines the validity interval of decryption keys generated by a key generation system (not shown) for each exhibition theater to so that the destination theater can decrypt and play the otherwise encrypted content during the booked show dates. If the client allows an exhibition theater to extend exhibition of one or more digital cinema presentations, the key generator will generate and send new keys to that exhibition theater, thereby avoiding the need for additional replication and redistribution of content. Note that while digital cinema features and shorts undergo encryption, trailers and advertisements do not.

In accordance with the present principles, one or more work orders will indicate that a particular destination (e.g., exhibition theater) should receive content replicated on more than one physical storage device (e.g., more than one hard disk drive). This circumstance arises occur when different clients independently place separate work orders that book the same exhibition theatre for roughly the same show date, such that each booking may be served with a common shipping date. The system 100 of the present principles advantageously accomplishes efficient replication and packaging of a group of content storage devices for shipment together to a common destination (e.g., exhibition theater), thereby reducing handling and shipping costs.

The distribution and logistics server 131 of the distribution system 130 has access to the physical media information database 122 populated by the replication server 121 with information, including the destination for a group of replicated and now packed content storage devices 145. The distribution and logistics server 131 connects to each of barcode scanners 132 and 133 for reading a barcode carried by each content storage device. Rather than make use of the barcode scanners 132 and 133, the distribution system 130 could make use of other types of well-known devices (not shown) capable of reading identifying indicia carried by each content storage device. Using the barcode scanners 132 and 133 (or other such devices), the distribution and logistics server 131 can track: (1) each incoming storage device 141, (2) the content storage devices 143 staged in inventory 140 for replication, (3) the content storage devices 145 already replicated, as well as (4) the content storage devices 146 packed for shipment. The distribution and logistics server 131 connects to a shipping label printer 134 that prints shipping labels 135 with the destination for each group of content storage device(s) 146 undergoing shipment in a common shipping container 181.

The system of FIG. 1 practices a replication and distribution process 160 that proceeds generally as follows. The system 100 receives an incoming content storage device 141 during step 161 when an exhibition theater returns a content storage device, whereupon the barcode scanner 132 scans a barcode 142 (or other identifying indicia) on that device for registration by the distribution logistics server 131. At this time, the distribution and logistics server 131 can update the status of that content storage device to “ready inventory” in advance of that device undergoing restocking into the inbound inventory 140 during step 162. Once restocked, this content storage device now becomes a “ready” content storage device 143 (i.e., a content storage device ready for subsequent replication). These steps repeat multiple times over the life of a content storage device, each time an exhibition theater returns the content storage device after use.

Still referring to FIG. 1., in accordance with the present principles, an operator (not shown) can successively pull each of a set of multiple arbitrary content storage devices 171 from the inbound inventory 140 for insertion into the replication array 123 as an “in bay” content storage device group 172 during step 163. When inserted into replication array 123, each storage device 144 can be detected by replication server 121 and can be individually identified by an electronically readable serial number (not shown), corresponding to that same device's unique indicia 142 in physical media information database 122. This correspondence eliminates any need for an operator to identify which storage devices are inserted into which locations in replication array 123.

Once inserted into replication array 123, the individual “in bay” content storage devices of the group 172, (e.g. the storage devices 144), each undergo erasure and testing as needed and according to policy, before being selected to receive content. Following content replication where different content is written to each of the devices 144 in the group 172, verification of those drives occurs, again, according to policy. These steps all occur under the direction of the replication server 121. Here, the replication server 121 has selected the content storage devices in the content storage device group 172 as the destination for content for collective shipment as a group to a common destination. (Note the storage devices of the group 172 need not reside contiguous to each other in the replication array 123, though that is preferable.)

The instructions for replicating content onto multiple content storage devices for delivery to a common destination may come from one or more work orders. However, the replication server 121 advantageously gathers this information to create a single replication job to accomplish content replication onto the content storage devices in the group 172 at roughly the same time. Upon completion of replication of content onto all of the content storage devices in the group 172, the replication server 121 will flag the content storage device group 172 for removal. During step 164, an operator will remove the content storage devices in the group 172 and place these storage devices (now identified by the reference number 145) in a ready group 173 for packing in a shipping container 180 placed in the outbound inventory 150. Each of the content storage devices (e.g., the devices 145) in the ready group 173 has a corresponding status set by replication server 121 in the physical media information database 122. The status set by the replication server 121 designates that the content storage devices 145 in the group 173 should ship together to the common destination (as established from the corresponding work order(s) in database 112). All of the content storage devices of the group 173 will receive the same status.

During step 165, the operator will pull the shipping container 180 from the outbound inventory 150 and verify the physical contents of the container for shipment. To verify the container 180, the operator will read the indicia of at least one content storage device (e.g., content storage device 146) from the container, typically by scanning the content storage device with the barcode scanner 133, which provides the distribution and logistics server 131 the appropriate reference with which to access the physical media information database 122. Once verified, the shipping container 180 from the outbound inventory 150 becomes shipping container 181, ready for shipping step 166.

In cases with low operator error rates expected, the reading of a single content storage device indicia by the barcode scanner 133 will generally suffice to determine the common destination from the physical media information database 122 for printing the corresponding shipping label 135. However, with new or probationary employees, or as a statistical spot check, or as a matter of policy, policy could require that the operator read the indicia of every content storage device in the container 181. After the operator reads the indicia of each content storage device in the container 181, then logistics server 131 can verify the presence of all the content storage devices in the group destined for shipping to the common destination.

In some embodiments, policy may be that if the container 181 lacks one or more of the required storage devices and nothing more, then the replication server 131 will split the job. The replication server 131 will separate the missing content storage device from the group, and designate the missing storage device as a separate independent job. The missing content storage device, once detected, now becomes a new (smaller) content storage device group and shipping of that storage device can proceed. This policy avoids slowing the processing and shipment of the container 181 (and subsequent containers) in an attempt to “fix” the shipment by searching for the missing content storage device in the outbound inventory 150. The system 100 could implement a different policy in connection with a light workload, a small outbound inventory 150, and no imminent shipping deadlines. Under such circumstances, the system 100 could allow searching for the missing content storage device(s) and adding such devices, when found, to the shipping container 181 so that the container passes verification.

If the shipping container 181 includes one or more content storage devices that do not belong in the shipment, the operator will remove these storage devices for subsequent processing as a new (smaller) content storage device group as discussed above. Alternatively, the distribution and logistics server 131 could reject the container 181 as a matter of policy. Under such circumstances, an operator will remove all of the content storage devices from the container 181 and restock them in the inbound inventory 140, or set them aside in the hope of rehabilitating the shipment by treating the shipment as has having a missing content storage device (if policy allows). In some cases, if the distribution and logistics server 131 determines that a valid destination exists for an inappropriately included content storage device, an operator can pack that content storage device separately (not shown) and print a corresponding shipping label 135.

When the distribution and logistics server 131 retrieves the shipping information from the physical media information database 122 corresponding to indicia read from a content storage device 146, the server signals the label printer 134 to print the shipping label 135 for application to the now ready-for-shipment shipping container 181. During step 166, the operator dispatches the packaged content storage device group to a common carrier (e.g., Federal Express, DHL, Roadway Express for example) for shipping to the corresponding exhibition theater (i.e., the common destination). The distribution and logistics server 131 then updates the database 122 to set the status of the content storage device 146 read by the barcode scanner and the rest of the content storage devices in the shipping container 181 (whether actually scanned or merely presumed as included in the container) as “out”. The distribution and logistics 131 server may track the progress of these now-shipped content storage devices by communicating with computers (not shown) operated by the corresponding shipping company. The content storage devices in the shipping container 181 remain “out” until the distribution and logistics server 131 subsequently discovers these storage devices as individually returned during step 161. Thus, in accordance with the present principles, the system 100 advantageously aggregates multiple content storage devices destined for a common destination into a single shipment.

FIG. 2 illustrates a more detailed block diagram of content replication system 120. In particular, FIG. 2 shows the components an exemplary embodiment of the replication array 123, which comprises an arrangement 200 of docking bays, some shown empty (e.g., docking bay 210), while others mount a content storage device (as does bay 211). Each docking bay (e.g., bay 210) has an associated indicator (e.g., indicator 206), in immediate, unambiguous physical proximity to that bay. Each indicator 206 comprises a light source such as a bulb or LED, and provides a visual indication in the form of light emitted in a particular color or pattern (e.g., animation). An indicator controller 203 controls the indicators 206 responsive to the replication server 121 to indicate the status of the corresponding content storage device or bay. The indicators 206 may have configuration that allows direct viewing by an operator. Alternatively, the indicators 206 could project light onto the content storage devices themselves (as shown herein). As the replication server 121 updates the status of each content storage device (or docking bay, as shown in FIG. 2), the corresponding indicator will reflect that change.

Each docking bay has a corresponding power supply 205. Alternatively, multiple bays could share a single power supply. A power controller 204 controls the corresponding power supplies 205 responsive to the replication server 121. In this way, the replication server 121 can save energy by powering down content storage devices in the bay arrangement 200 when not needed. Further, the replication server 121 can also power cycle the content storage devices in the bay arrangement 200 as needed during certain content storage device initialization functions (e.g., content storage device clipping, also known as “Host Protected Area” or “HPA”).

The replication server 121 further controls one or more media controllers 201 connected to the content storage device in the bay arrangement 200 to effect the replication of content onto the storage devices. Additionally, the bay arrangement 200 can have an associated content cache 202, for example a RAID (redundant array of inexpensive disks), so that during replication of content onto the content storage devices in the bay arrangement 200, the replication server 121 need not completely rely on the bandwidth available on its connection to the content store 113. In some embodiments, an operator could insert a master content storage device (not shown) into a designated docking bay in the bay arrangement 200. Under such circumstances, the replication server 121 could transfer content from that master content storage device for replication onto to the content storage devices in other docking bays. When necessary, the replication server 121 can maintain a configuration database 221 that records the association between an individual docking bay (e.g., bay 210), an individual indicator (e.g., indicator 206), the corresponding controller 203 for that indicator, the media controller 201, and the power controller 204, as well as appropriate port and/or other hierarchical designations within each device.

Different animations and/or different colors of the indicators 206 convey status information to an operator tasked with servicing the bay arrangement 200. For example, no light for particular content storage device bay 211 can indicate that a content storage device mounted in that bay remains idle. An indicator displaying a pulsing blue light, such as pulsing lights 214 and 217, indicates a content storage device actively receiving content. A steady green light 212 indicates a content storage device ready for shipping. A blinking red indication 213 indicates a content storage device that has repeatedly failed quality tests, signaling that an operator should discard this storage device. While the indicators 206 could provide many more details about the status of individual content storage devices, the indicators primarily indicate what action an operator should take next (e.g., “ship” or “discard” this content storage device) or which action an operator should not take (e.g., “do not interrupt as this content storage remains subject to content replication).

The brightness or speed of an animation can convey a sense of urgency. For example, a fast blinking green might represent a high priority shipment as compared to a steady green meaning “ready to ship”. In accordance with the present principles, a yellow light could indicate the readiness of a group 215 of content storage devices for shipping as a unit so an operator should remove and this group of storage devices and pack them together into the shipping container 180. Note that no need exists for the content storage devices in a particular group to reside adjacent to each other as depicted for the content storage device group 215 in FIG. 2. For example, after an operator has removed the content storage devices in the group 215, the media controller(s) 201 will detect the removal of these storage devices and inform the replication server 121 accordingly. In response, the replication server 121 will direct the indicator controller(s) 203 to extinguish the lights on the bays previously containing just-removed the content storage devices in the group 215. Now, the indicator controller(s) 203 can light the indicators for next group of content storage devices with the same indication (i.e., yellow), as shown for the three content storage devices 216 (shown as not contiguously positioned in replication array 123). If a group has almost, but not quite finished replication, i.e., a content storage device 217 still receives content, the replication content server 121 will hold off illuminating the indicator for any of the group of storage devices to be pulled. Thus, the replication server 121 will only light the indicators for only one group of storage devices to designate removal, and only when the all the content storage devices entire group have completed replication.

Even when the indicator controller 203 provides just a few different animations, the replication server 121 can provide a variety of quickly discernable indications of various intuitively readable degrees of urgency or severity. A solid, but dim red might indicate a content storage device that failed during content replication, whereas a bright, rapidly blinking red might indicate a content storage device that repeatedly failed tests and resisted recovery attempts, signaling that an operator should discard that device. While a solid green indicator could signal a content storage device ready to ship, a rapidly blinking green might indicate an urgent shipment. Pulsing lights (as described above) that brighten and dim smoothly, whether or not rapidly, may prove less grating on operators than hard blinking, and therefore more suitable for long operations in progress or idle status. Well-chosen animations can improve an operator's ability to identify a group of content storage devices, especially when the storage devices of that group lie scattered in the bay arrangement 200 of FIG. 2. For example, when seeking to signal removal of a set of commonly grouped content storage devices 216 (i.e., after removal of the group 215), the replication server 121 could signal the indicator controllers 203 to light the corresponding indicator(s) 206 yellow. However, an operator could more easily recognize the indicators 206 when animated as a rapidly flashing yellow light. If during this yellow flashing of the indicators, no other fast animation occurs (i.e., no “urgent shipment” indication by way of rapid green flashes), then identifying the content storage devices belonging to the group becomes very clear to the operator. Once the replication server 121 detects removal of the last of the content storage devices associated with the flashing yellow indicators, then the replication server can initiate flashing of the indicators to an indicate urgent shipment content storage devices (not shown) to signal their need for individual shipment.

The foregoing discussion presumes the presence of one or more human operators for performing the insertion of content storage devices into the bay arrangement 200 and the removal therefrom, as well as the packing and shipping of such devices. Note that one or more robots (not shown) could perform the tasks otherwise performed by human operator(s). In this regard, the replication server 121 and the distribution and logistics server 131 would interface with the controller(s) for such robot(s). While use of robots could obviate the need for the indicators 206 and their associated controller 203, keeping the indicators even when using robots could provide an additional control mechanism. Under such circumstances, each robot would include an image capture device, such as a television camera or the like (not shown), for viewing the indicators. The image capture device on each robot would capture the animation of each indicator, which the robot's controller would use, at least in part, to controlling the robot's actions.

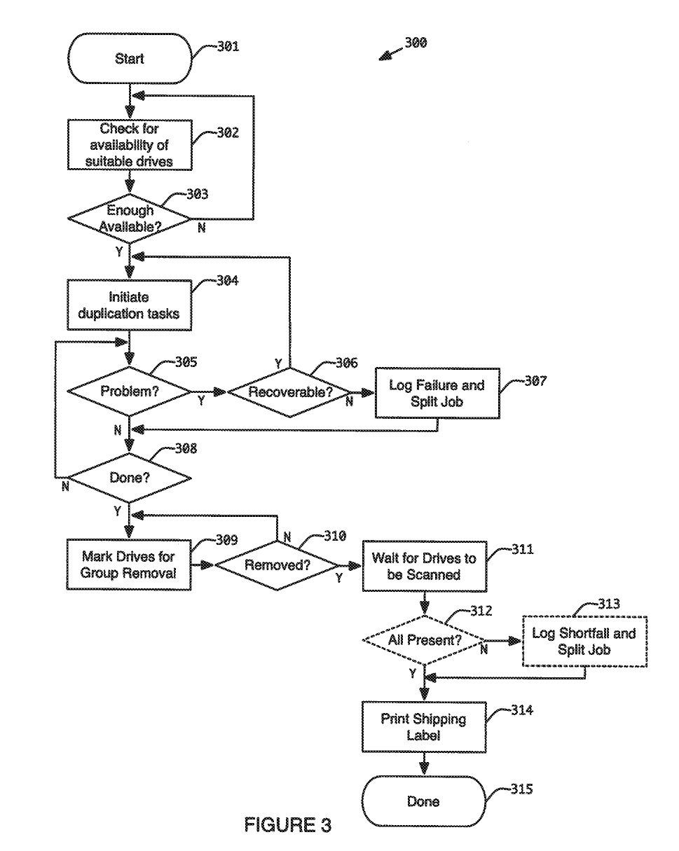

FIG. 3 depicts, in flow chart form, the steps of a process 300 for content storage device group replication. The process 300 begins during step 301 triggered by one or more content replication requests (as derived from received work orders), which collectively call for delivery of a plurality of content storage devices to a common destination, that is, multiple content storage devices destined for a single exhibition theatre. The collection of requests for replication of content onto separate content storage devices for delivery to the same exhibition theatre, whether coordinated by a single work order or noted as a coincidence among more than one work order, becomes a “multi-content storage device job” managed by the balance of group replication process 300.

After an operator mounts the content storage devices in one or more of replication arrays 123 of the replication system 120 as in step 163 of FIG. 1, the replication server 121 of FIG. 1 executes step 302 and examines the storage devices and evaluates suitability for the job (e.g., their individual sizes are adequate). During step 303, the replication server 121 will determine whether enough content storage devices of an appropriate size exist for the multi-content storage device job. If not, then the process reverts to step 302, perhaps alerting the operator (not shown) of the need for more content storage devices, including notice, perhaps, of a need for particular size device(s).

After step 303, after the replication server 121 has determined that enough content storage devices (of appropriate size) are available, then step 304 executes and the replication server seizes these devices and begins the replication of the specified content. Typically, replication of content onto all or several of the content storage devices occurs in parallel. During step 305, if the replication server 121 detects a problem with content replication, the replication server initiates a further test 306 to determine whether the problem is recoverable. If the problem is recoverable, the replication server 121 resumes or restarts the problematic duplication tasks during step 304. In some cases, the replication server 121 will need to allocate new content storage devices for use when restarting.

However, if recovery remains impossible (e.g., content intended for a particular storage device is not available or is corrupted) or a recovery attempt would take too long (e.g., the multi-content storage device job was nearly completed), then during step 307, the replication server 121 logs the failure for later diagnosis and splits the multi-content storage device job. The replication server 121 now drops the failed content storage device from the multi-content storage device job, and a queues a new content storage device job. This approach proves valuable when, for example, four content storage devices undergoing replication have completed 90% copying but now one content storage devices fails and needs complete restarting. Rather than retain the three content storage devices that did not fail in their corresponding content storage device bays (thereby wasting that replication resource), the replication server 121 will allow these content storage devices to complete their content replication. Thereafter, the replication server 121 will signal the operator to pull and ship these storage devices. Later, the replication server 121 can restart copying of the failed content storage device for subsequent shipping. In this way, the content storage devices successfully replicated with content can ship in timely manner and a smaller shipment can follow later with a subsequently replicated content storage device substituting for the one that failed. Alternatively, the portion of the job associated with the failing storage device can be re-queued, perhaps to be included in a subsequent multi-content storage device job to the same destination. During step 308, the replication server 121 determines whether all the content storage devices have finished replication of the content specified in the job. If not, then the content storage device group replication process 300 continues to monitor progress by looping back to step 305.

When, during step 308, the replication server 121 determines that the replication of content for all the content storage devices has completed (which may be all the content storage devices remaining in the job after a split at 307), then during step 309, the replication server will mark the content storage devices belonging to the group (e.g., by appropriately animating the indicators for the corresponding bays 215). Such signaling will alert the operator that the content storage devices are ready for shipping as a group.

During step 310, the replication server 121 of FIG. 1 determines whether the operator has removed all the content storage devices now marked. If any of the content storage devices still remain in the bay arrangement 200 of FIG. 2, then the process 300 of FIG. 3 loops back to step 309 and the replication server 121 now marks the remaining content storage devices for removal. Once the replication server 121 determines during step 310 that the operator has removed all the content storage devices in the group marked for shipping, the replication server waits for any or all of the content storage devices (depending on the embodiment of process 300) to undergo scanning by the distribution and logistics server 131 during step 311.

If the policy requires all outbound content storage devices undergo scanning individually, then during step 312, the replication server 121 undertakes a check to determine whether the operator has scanned all of the content storage devices in the multi-content storage device group, If not, then during step 313, the replication server 121 logs the shortfall (e.g., the missing content storage device(s)), Thereafter, the replication server 121 then splits job (much as during step 307) after which, the replication server notes now ready-to-ship multi-content storage device job as including only the content storage devices scanned. The replication server 121 now re-queues of the missing content storage devices, as well the content they represent, as a separate job. Some environments may require securing the replication system 120 and/or outbound inventory 150 in a way that prevents operators working with distribution system 130 from effectively searching for missing content storage devices. This approach of splitting the replication job based on the unavailability of a content storage device can address such situations. In other circumstances, under a different policy, a search for the missing content storage device can occur during step 311 until the operator succeeds and completes the multi-content storage device group, or abandons the search.

In another embodiment, policy may dictate that only one content storage device of a group to undergo scanning during step 311. Such a policy may exist because of accumulated experience or the expectation that a group of content storage devices successfully removed (following steps 309 and 310) will undergo packing together (e.g., packing of all of the storage devices in the shipping container 180). As the container 180 moves from the outbound inventory 150 for handling in the distribution system 130 for verification during step 165 of FIG. 1 (becoming the container 181), the group of content storage devices will not experience any disruption. In other words, the content storage device pulled during step 164 of FIG. 1 will undergo scanning during step 165 of FIG. 1, so a scan of one content storage device serves adequately to identify the destination. Thus, a scan of more content storage devices under such a policy is redundant. In such an embodiment, steps 312 and 313 remain unnecessary (hence their depiction in FIG. 3 with a dotted outline).

During step 314, the distribution and logistics server 131 uses any one of the content storage device indicia read during 311 to look up the common destination from the physical media information database 122. The distribution and logistics server 131 uses the destination to print the shipping label 135 from the printer 134. The operator applies the label 135 to the shipping container 181 and during step 315, the content storage device group replication process 300 concludes at step 315 with the container 181 ready to ship during step 166 of FIG. 1.

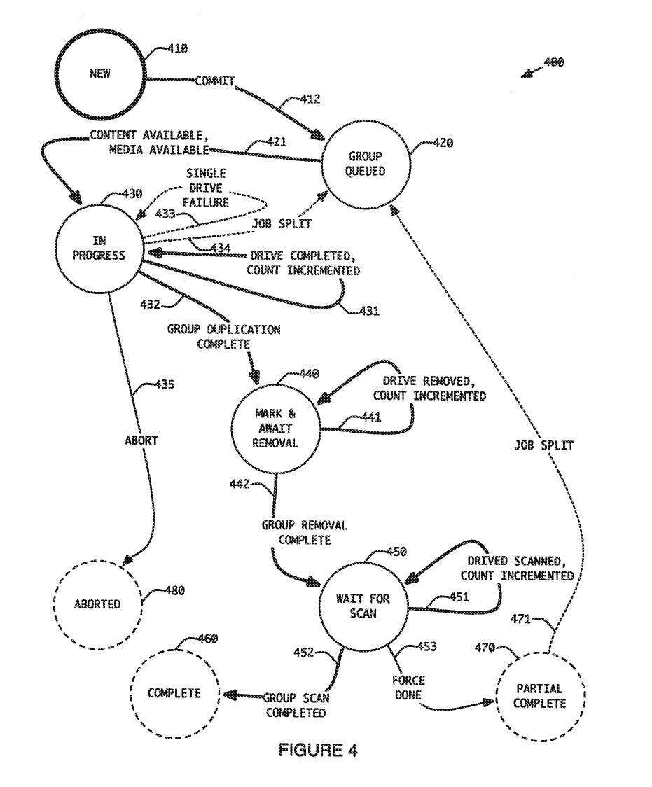

FIG. 4 illustrates job state transition diagram 400, which shows the progression of different states through which a group replication job can proceed. As the booking system 110 of FIG. 1 receives work orders for entry into the work order database 112 of FIG. 1 and upon identification of such work order(s) singly or collectively calling for a delivery of a plurality of content storage devices to a common destination, creation of a new content storage device group job occurs during the NEW state 410. During the transition 412, the content storage device group job status becomes the GROUP QUEUED state 420, where it will wait until the required content becomes available in the content store 113 of FIG. 1 and sufficient content storage devices become available in replicator array 123. When those criteria become met during the transition 421, the job enters the IN PROGRESS 430 state and one-by-one the content storage devices allocated to the job receive the specified content by incrementing a count of allocated devices, thereby reducing the number of additional content storage devices required for the job by one during the transition 431.

Once the entire group of content storage devices required for the job has successfully copied the specified content during the transition 432, the status of the replication job enters the AWAITING REMOVAL state 440. However, while the job remains in the IN PROGRESS state 430, a failure of the source content can occur (e.g., the content checksums appear invalid), or another copy problem can arise, (e.g., content database 113 becomes unavailable), or the like, which causes a single content storage device failure during transition 433. Under such circumstances, then the replication server 121 of FIG. 1 can modify the group content storage device job to excise the requirement of the failed content storage device from the group. The original job, now with no requirement for the content associated with the failed copy attempt, continues in the IN PROGRESS state 430 while a job split occurs during the transition 434 to create and queue a new job comprising the just-excised requirement (as during step 307 of FIG. 3).

For embodiments that do not allow job splits, thus requiring a content storage device group job to complete on an all or nothing basis, then the failed copy operation can restart with the same or different content storage devices all while the job remains in the IN PROGRESS state 430. Alternatively, a persistent failure can induce an abort operation during the transition 435 to place the job in the ABORTED state 480. Similarly, a manual abort by an operator forcing the transition 435 can cancel the content storage device group job.

In some cases, aborting the replication of content onto single content storage device within a group can occur without aborting the content replication for the balance of the group. For example if four separate work orders specify sending different content storage devices to the same theatre, and the content storage device group job resides in the IN PROGRESS state 430, then upon cancellation of one of the work orders, a transition like transition 433 can occur. Taking the transition 433 excises the cancelled content storage device from the content storage device group job and the cancelled content storage device alone enters the ABORTED state 480. The rest of the content storage device group would continue until entering the transition 432.

While the replication job resides in the AWAITING REMOVAL state 440, the replication system 120 marks a group of completed content storage devices as ready for removal (step 309 of FIG. 2) by animating the appropriate indicators 206 of FIG. 2. As the replication server 121 of FIG. 1 detects the removal of each content storage device during the transition 441, the replication server increments the removal count until removal of all of the content storage devices in the group occurs during the transition 442, at which point the job enters the WAITING FOR SCAN state 450 (step 311 of FIG. 3).

In the embodiments discussed above where only one content storage device undergoes scanning, reading of the identifying indicia of a single content storage device in the group during the transition 452 completes this requirement. The content storage device group job now enters the COMPLETE state 460. However, for embodiments that require scanning of all of the content storage devices, then reading of the indicia on each content storage device in the group increments a count during the transition 451 until scanning of all of the content storage devices occurs during the transition 452 at which time, the job enters the COMPLETE state 460. However, in situations when the replication server 121 detects a shortfall (i.e., the operator only scans some of the content storage devices before indicating no more devices exist in the group) then job completion enters the transition 453, resulting in the content storage device group job entering a PARTIALLY COMPLETE state 470 (as during step 313).

This state allows shipping of the detected content storage devices, but re-queues the missing content storage devices by splitting the job during the transition 471 to create and queue new job comprising the required but currently missing content storage device (as during step 313). Both the COMPLETE state 460 and PARTIALLY COMPLETE state 470 allow for printing of the shipping label 135 for the container 181, regardless whether or not every content storage device (e.g., 146) undergoes scanning, thus making the container 181 ready for shipment during step 166 of FIG. 1.

In accordance with the present principles, the system 100 provides a technique for replicating content onto content storage devices for shipment to one or more destinations. Advantageously, the system 100 of the present principles can reduce the number of shipments, and correspondingly the amount of shipping charges for content storage devices destined for a common destination without substantially increasing the complexity of operator tasks, and without substantially increasing the likelihood of a missed or erroneous shipment.

1. A method for replicating content onto storage devices for shipping to a common destination, comprising the steps of
grouping work orders that specify replication of content onto a plurality of storage devices associated a common destination into a group replication job;
replicating content onto the plurality of storage devices, the content specified in the group replication job; and
readying for shipping to the common destination the plurality of content storage devices in the group replication job.

2. The method according to claim 1 further including the step of splitting the group replication job into sub-jobs when at least one of the plurality of content storage devices does not successfully copy content.

3. The method according to claim 2 wherein the step of readying for shipping further comprises the step of readying for shipping content storage devices associated with a first sub-job that have successfully copied content.

4. The method according to claim 2 further including the step of repeating content replication for the at least one of the plurality of content storage device that does not successfully copy content.

5. The method according to claim 2 further including the steps of:
selecting a different content storage device in lieu of the content storage device that did not successfully copy content; and
replicating content onto the different content storage device.

6. The method according to claim 1 wherein the step of readying for shipping includes the step of printing a shipping label specifying the common destination.

7. The method according to claim 1 further including the step of prioritizing the group replication job relative to other group replication jobs.

8. The method according to claim 1 further including the step of displaying an indication of content storage device status during replication.

9. The method according to claim 1 wherein the plurality of content storage devices are contiguously located in a replication system as content is replicated.

10. Apparatus comprising:
a replication system, system having access to a work order database for storing work orders that specify replication of content onto a plurality of storage devices for shipping to destinations; and for (a) grouping work orders that specify replication of content onto a plurality of content storage devices associated a common destination into a group replication job, and (b) replicating content onto the plurality of storage devices content specified in the group replication job; and
a distribution system for readying for shipping to the common destination the plurality of content storage devices in the group replication job.

11. The apparatus according to claim 10 further comprising:
a booking server for receiving work orders in a work order database.

12. The apparatus according to claim 10 wherein the replication system comprises:
a replication server coupled to the work order database for grouping the work orders and for replicating the content onto the storage devices specified in the work orders;
a content storage mechanism for storing content for use by the replication server; and
a physical media information database for storing information about the content storage devices generated by the replication server.

13. The apparatus according to claim 12 wherein the distribution system comprises:
at least one scanner for reading identifying indicia carried by at least one content storage device: and
a distribution and logistics server coupled to the at least one scanner and to the physical media information database for tracking content storage devices identified by the at least one scanner in accordance with information in the physical media information database.

14. The apparatus according to claim 13 wherein the distribution system also includes a shipping label printer responsive to the distribution and logistics server for printing a shipping label.

15. The apparatus according to claim 12 wherein the replication system further includes an arrangement of bays, each bay removably mounting and interfacing a content storage device to the replication server.

16. The apparatus according to claim 15 wherein the arrangement of drive bays includes indicator means for providing an indication of status of the content storage device in each bay.

17. The apparatus according to claim 16 wherein the indicator means comprises:
a light source; and
a controller for controlling the light source responsive to the replication server.

18. The apparatus according to claim 17 wherein the controller controls the light source to vary at least one of its color and pattern.

19. The apparatus according to claim 15 wherein the arrangement of bays further includes a content cache for storing content for replication onto the content storage devices removably mounted into the arrangement of bays.
